(19) United States
(12) Patent Application Publication
(10) Pub. No.: US 2019/0108198 A1
(43) Pub. Date: Apr. 11, 2019

(54) INFORMATION PROCESSING APPARATUS, METHOD OF CONTROLLING THE SAME, AND NON-TRANSITORY COMPUTER-READABLE STORAGE MEDIUM

(71) Applicant: CANON KABUSHIKI KAISHA, Tokyo (JP)

(72) Inventor: Masaki Yamamichi, Yokohama-shi (JP)

(21) Appl. No.: 16/148,047

(22) Filed: Oct. 1, 2018

(30) Foreign Application Priority Data
Oct. 5, 2017 (JP) 2017-195374

(51) Int. Cl. G06F 17/21; G06F 17/24

(52) U.S. Cl. CPC G06F 17/211; G06F 17/212; G06F 17/217; G06F 17/241

(57) ABSTRACT

An information processing apparatus comprises: an edit unit configured to edit document data based on an instruction of a user, wherein in a case in which an instruction to output document data of a vector format using a file format of a raster format is received, the edit unit outputs the document data using the file format of the instructed raster format, specifies, for each page included in the document data, whether to hold data of an object included in a page as data of the vector format or hold the data as data of the raster format, and holds each page including data of an object of the specified format as data for an edit.

### BACKGROUND OF THE INVENTION

### Field of the Invention

The present invention relates to an information processing apparatus, a method of controlling the same, and a non-transitory computer-readable storage medium.

### Description of the Related Art

In an document edit application, there exists a document data file format capable of including various data, for example, image data such as bitmap data, text data such as a character string, and graphic data such as a rectangle as drawing objects.

The document edit application can add a specific character string or a graphic such as a rectangle or an ellipse to a page that forms document data. The document edit application can also perform an image edit of painting some of images that form a page or image correction of adjusting the total tint to change a whole image to grayscale or correcting a tilt or the like. In addition, the document edit application can save document data on which a result of an edit is reflected as a different file format. For example, a PDF (Portable Document Format) file is opened as an edit target and, after a character string or the like is added to an arbitrary page, saved as image data of a different file format. Subsequently, for example, a whole page is changed to grayscale as an image. Such a series of processes can be performed by one document edit application.

Japanese Patent Laid-Open No. 2005-157905 discloses a technique of performing vectorization processing for document data formed by an image. That is, when editing an image, it can be edited like text data or graphic data.

However, even if vectorization processing from an image is performed, the characteristic of a drawing object that is the base of the image is not completely reproduced. For example, the type of the drawing object and what kind of attribute value the drawing object has are not completely reproduced, so it is difficult to do an edit while maintaining the characteristic of the drawing object. For this reason, if document data of a file format capable of including vector data is saved in a file format capable of holding only images, and information other than the images disappears, it is impossible to perform a re-edit while maintaining the characteristic of the drawing object.

To avoid such an uneditable state, the original drawing object is continuously held as vector data even after saved as an image. In this case, since the edit target is not an image, edit processing such as the above-described grayscale conversion of an image cannot continuously be performed. For this reason, if imaging or vector data holding is performed uniformly for all pages, an image edit cannot be performed, or a vector data re-edit cannot be performed depending on the page. Hence, the efficiency of an edit for document data lowers, and user convenience deteriorates.

### SUMMARY OF THE INVENTION

According to one aspect of the present invention, there is provided an information processing apparatus comprising: an edit unit configured to edit document data based on an instruction of a user, wherein in a case in which an instruction to output document data of a vector format using a file format of a raster format is received, the edit unit outputs the document data using the file format of the instructed raster format, specifies, for each page included in the document data, whether to hold data of an object included in a page as data of the vector format or hold the data as data of the raster format, and holds each page including data of an object of the specified format as data for an edit.

According to another aspect of the present invention, there is provided a method of controlling an information processing apparatus including an edit unit configured to edit document data based on an instruction of a user, wherein in a case in which an instruction to output document data of a vector format using a file format of a raster format is received, the document data is output using the file format of the instructed raster format, whether to hold data of an object included in a page as data of the vector format or hold the data as data of the raster format is specified for each page included in the document data, and each page including data of an object of the specified format is held as data for an edit by the edit unit.

According to another aspect of the present invention, there is provided a non-transitory computer-readable storage medium for causing a computer to function as an edit unit configured to edit document data based on an instruction of a user, wherein in a case in which an instruction to output document data of a vector format using a file format of a raster format is received, the edit unit outputs the document data using the file format of the instructed raster format, specifies, for each page included in the document data, whether to hold data of an object included in a page as data of the vector format or hold the data as data of the raster format, and holds each page including data of an object of the specified format as data for an edit.

According to the present invention, it is possible to continue the edit operation more efficiently on a page basis even after document data is saved in another file format.

Further features of the present invention will become apparent from the following description of exemplary embodiments (with reference to the attached drawings).

### BRIEF DESCRIPTION OF THE DRAWINGS

FIG. 1 is a block diagram showing an example of the hardware arrangement of an information processing apparatus according to the embodiment of the present invention;

FIG. 2 is a block diagram showing an example of the software configuration of the information processing apparatus according to the embodiment of the present invention;

FIG. 3 is a view showing an example of the data structure of document data according to the embodiment of the present invention;

FIG. 4 is a view showing an example of the data structure of an object list according to the embodiment of the present invention;

FIG. 5 is a view showing an example of the data structure of a vector edit history according to the embodiment of the present invention;

FIGS. 6A and 6B are flowcharts of saving with another name according to the embodiment of the present invention;

FIG. 7 is a view showing an example of document data according to the embodiment of the present invention;

FIGS. 8A and 8B are views showing document data before and after saving with another name according to the first embodiment;

FIG. 9 is a flowchart of edit processing of vector data according to the first embodiment;

FIG. 10 is a flowchart of edit processing of an image according to the first embodiment;

FIG. 11 is a view showing an example of the main window of a GUI unit according to the first embodiment;

FIGS. 12A and 12B are views showing document data before and after an edit of vector data according to the first embodiment;

FIG. 13 is a view showing an example of a message for promoting determination of imaging according to the first embodiment;

FIGS. 14A and 14B are flowcharts of saving with another name according to the second embodiment; and

FIG. 15 is a view schematically showing the drawing layer of document data according to the embodiment of the present invention.

### DESCRIPTION OF THE EMBODIMENTS

A mode for carrying out the present invention will now be described with reference to the accompanying drawings.

### First Embodiment

### System Arrangement

In this embodiment, all the functions of a document edit system and a document management system according to this embodiment are implemented by a general information processing apparatus (PC: Personal Computer).

### Hardware Arrangement

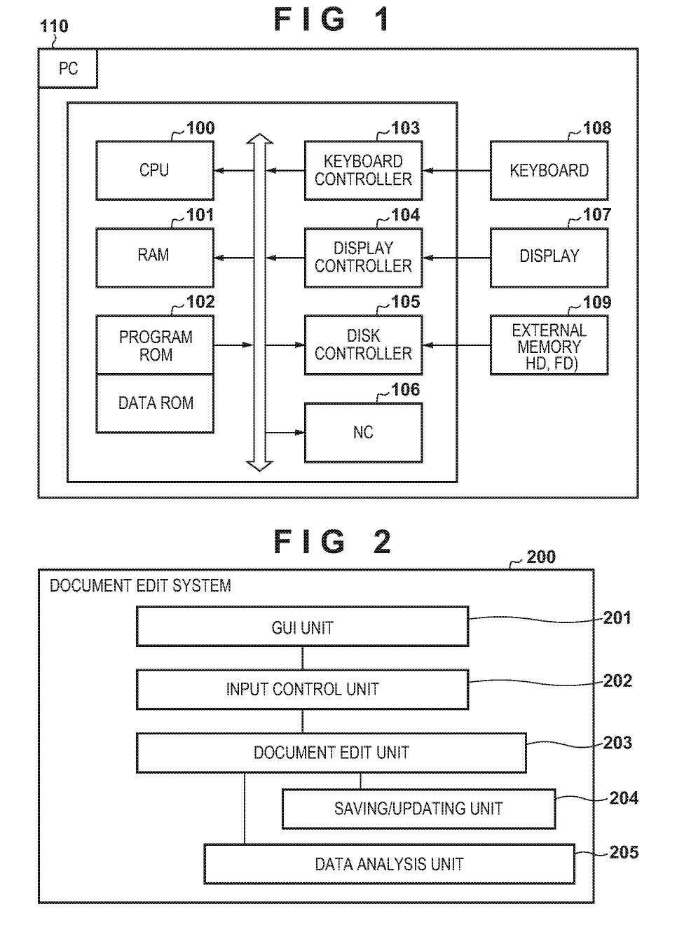

FIG. 1 shows an example of the hardware arrangement of the PC that forms the document edit system according to the embodiment of the present invention. The hardware arrangement shown in FIG. 1 corresponds to the hardware arrangement of a general information processing apparatus. However, the arrangement is not limited to this and may include another parts. In addition, the present invention is not limited to the PC, and may be applied to another information processing apparatus such as a portable terminal.

Referring to FIG. 1, a CPU 100 executes a program such as an operating system (OS) or an application stored in the program ROM of a ROM 102 or loaded from a hard disk (HD) 109 into a RAM 101. The processing of each flowchart to be described later is implemented by executing a program by the CPU 100. The RAM 101 functions as the main memory, work area, or the like of the CPU 100. A keyboard controller 103 controls input from a pointing device (not shown) such as a keyboard 108 or a mouse. A display controller 104 controls display on a display 107. A disk controller 105 controls data access in the hard disk (HD) 109, a floppy® disk (FD), or the like, which stores various kinds of data. An NC 106 is a network controller, which is connected to a network and executes communication control processing with another device connected to the network.

### Software Configuration

FIG. 2 shows an example of the software configuration of a document edit system 200, which is executed on a PC 110 according to this embodiment. All the functions of the document edit system 200 according to this embodiment are implemented by a program executed on the PC 110, as described concerning the hardware arrangement.

The document edit system 200 provides a function of loading document data and editing it to a user. As the document data here, either of data in a file format capable of holding vector data such as an image or a text and data in a file format capable of holding only image data can be used. Examples of document data file formats as described above are a PDF file and a bitmap file. Note that the file formats are not particularly limited, and another file format may be used as long as it has the above arrangement. Note that an extension given to a file name changes between these file formats.

The document edit system 200 includes a graphic user interface (GUI) unit 201, an input control unit 202, a document edit unit 203, a saving/updating unit 204, and a data analysis unit 205.

The GUI unit 201 provides a screen to be displayed on the display 107 of the PC 110, and receives input from an input device such as a keyboard or a mouse. The input control unit 202 detects a user operation performed on the screen provided by the GUI unit 201, and instructs a document data edit, file saving, or the like in accordance with the operation. The document edit unit 203 controls various kinds of edit processing for document data under an edit in the document edit system 200 in accordance with an edit instruction from the input control unit 202. The saving/updating unit 204 instructs document data saving/updating in accordance with an edit instruction from the input control unit 202. The data analysis unit 205 analyzes document data and generates an object under the control of the document edit unit 203.

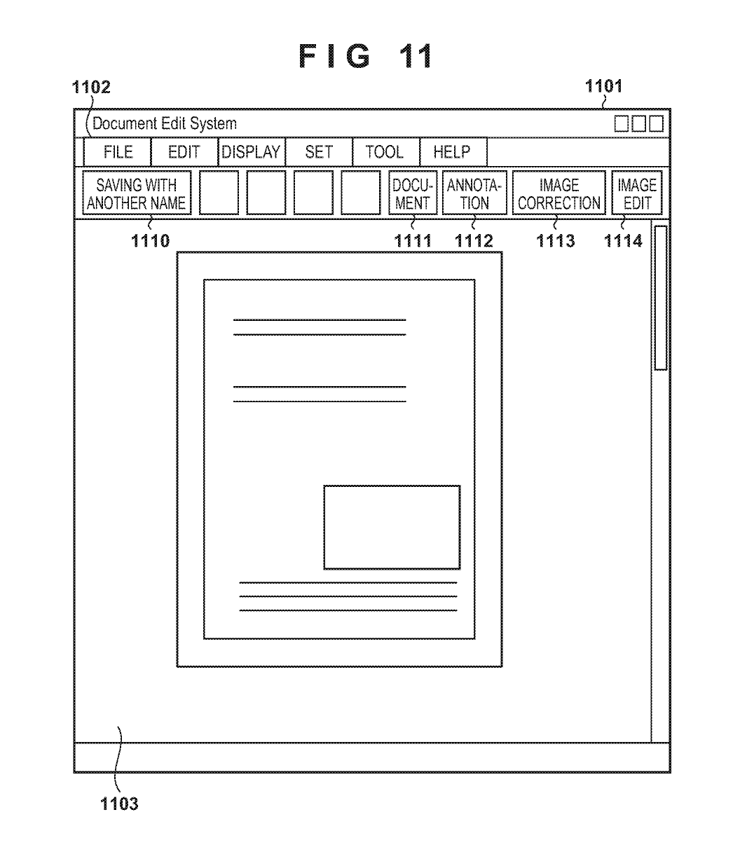

FIG. 11 shows an example of the arrangement of a screen provided by the GUI unit 201 of the document edit system 200. The screen provided by the GUI unit 201 is formed by a main window 1101, a menu/tool bar 1102, and a page preview 1103. Controls corresponding to various kinds of functions provided by the document edit system 200 are arranged on the menu/tool bar 1102. For example, assume that document data is formed by two drawing layers, that is, a document layer that arranges an object representing a document text and an annotation layer that gives an annotation. Here, the annotation layer is the upper layer. In this case, a control 1111 configured to given an object in the document layer, a control 1112 configured to give an annotation, a control 1113 configured to perform correction of an image, a control 1114 configured to perform an edit of an image, and the like exist.

In the page preview 1103, the drawing contents of each page of document data are displayed as a preview image. The drawing contents are decided by object data or image data.

### Data Structure

An example of the data structure of document data according to this embodiment will be described. Document data has a structure that imitates a book as a paper medium. First, the upper layer is called “document”, and an attribute (document attribute) concerning the whole document is defined. The lower layer is “page”, which corresponds to each page defined in the document edit system 200. Note that for each page as well, an attribute (page attribute) on a page basis can be defined. The page attribute corresponds to a page number, a page size, or the like. In addition, one document can include a plurality of pages. Note that “document” and “page” are terms used to explain the structure of document data, and other terms may be used if the structure is the same.

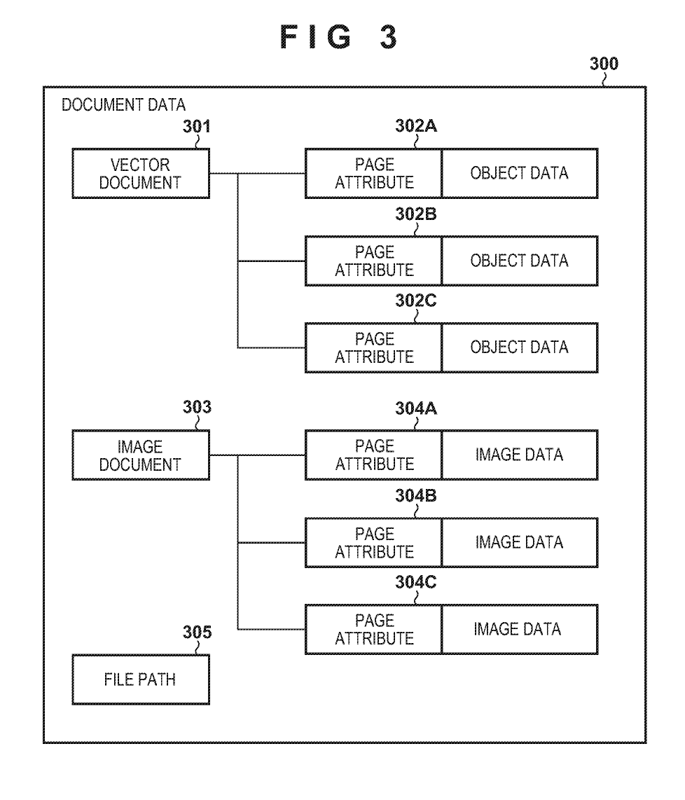

FIG. 3 is a view schematically showing an example of the format of document data according to this embodiment. In this example, the document data can store a vector document or an image document. One document data holds one of a vector document and an image document. More specifically, a vector document exists when a vector document file is opened as an edit target or when the object data of a vector document is edited. On the other hand, an image document exists when an image file is opened as an edit target. In the following explanation, “vector data” or “object data” means data of a vector format. In addition, “image data” means data of a raster format such as a bitmap image.

In document data, each of a vector document and vector pages is represented by a corresponding node. Each node includes a link to a lower layer as its entity. A vector page includes data of each page as an entity. For this reason, the vector page includes the entity (object data) of the vector page in addition to its attribute value.

Similarly, in document data, each of an image document and an image page is represented by a corresponding node. Each node includes a link to a lower layer as its entity. An image page includes data of each page as an entity. For this reason, the image page includes the entity (image data) of the image page in addition to its attribute value.

FIG. 3 shows that three vector pages 302A, 302B, and 302C are linked with a vector document 301, and the vector document 301 includes these vector pages. Each of the vector pages 302A, 302B, and 302C has a defined page attribute and includes object data that is the entity of the vector page. As the object data, for example, information of a vector format defined by the PDF format is described. Note that a case in which the vector document 301 is included in document data 300 means that the format (extension) of the document data 300 is a format other than the raster format such as a bitmap file.

In addition, FIG. 3 shows that three image pages 304A, 304B, and 304C are linked with an image document 303, and the image document 303 includes these image pages. Each of the image pages 304A, 304B, and 304C has a defined attribute value and includes image data that is the entity of the image page. As the image data, information of the raster format is described.

A file path 305 stores a path to a file currently associated with the document data 300. The association between files will be described later along with a procedure.

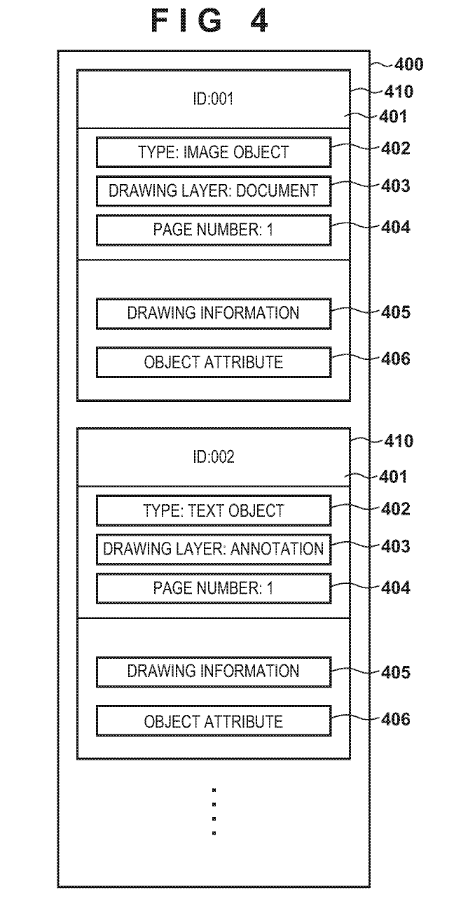

FIG. 4 shows an example of an object list used as the object data of each vector page of document data. An object list 400 is a list used to manage object data arranged in each vector page. Each object data includes an ID 401, a type 402, a drawing layer 403, a page number 404, drawing information 405, and an object attribute 406. The ID 401 is identification information used to uniquely identify object data in the object list 400. The type 402 represents the type of an object and shows, for example, an image object or a text object. The drawing layer 403 is a layer in which an object exists. As described above, in this embodiment, document data is formed by two layers, that is, a document layer and an annotation layer, and one of them is designated. The page number 404 represents a page in which an object is drawn in the document. The drawing information 405 represents the position or size of a document object. The object attribute 406 is unique information about an object. One or a plurality of object data 410 having such a structure is stored in the object list 400 in a list structure.

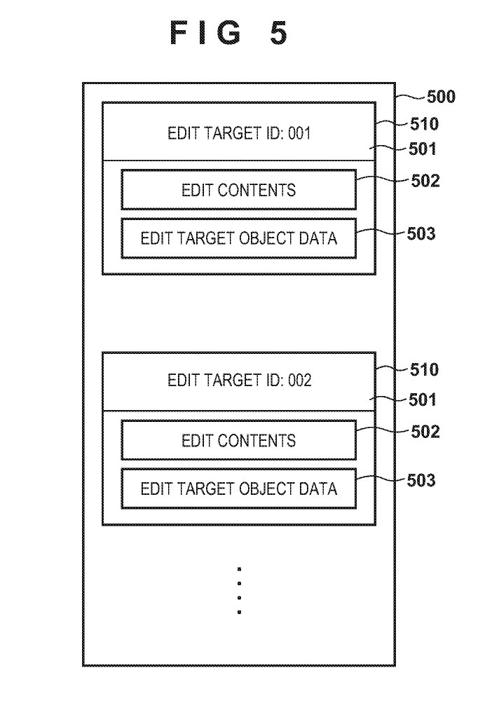

FIG. 5 shows an example of vector edit history data according to this embodiment. Vector edit history data 500 is the history data of an edit for object data of a vector document, and is formed by one or a plurality of vector edit data 510. Note that if the object data has never been edited, the vector edit history data 500 does not exist (or is empty). The vector edit data 510 stores an edit target ID 501 and edit contents 502. The edit target ID 501 represents the ID of edited object data and corresponds to the ID 401 shown in FIG. 4. The edit contents 502 represent the contents of an edit for the object data and show, for example, addition, deletion, or movement. In addition, when object data is erased from the object list 400 by deletion of an object or the like, the erased object data is stored as edit target object data 503.

### Processing at Time of Saving with Another Name

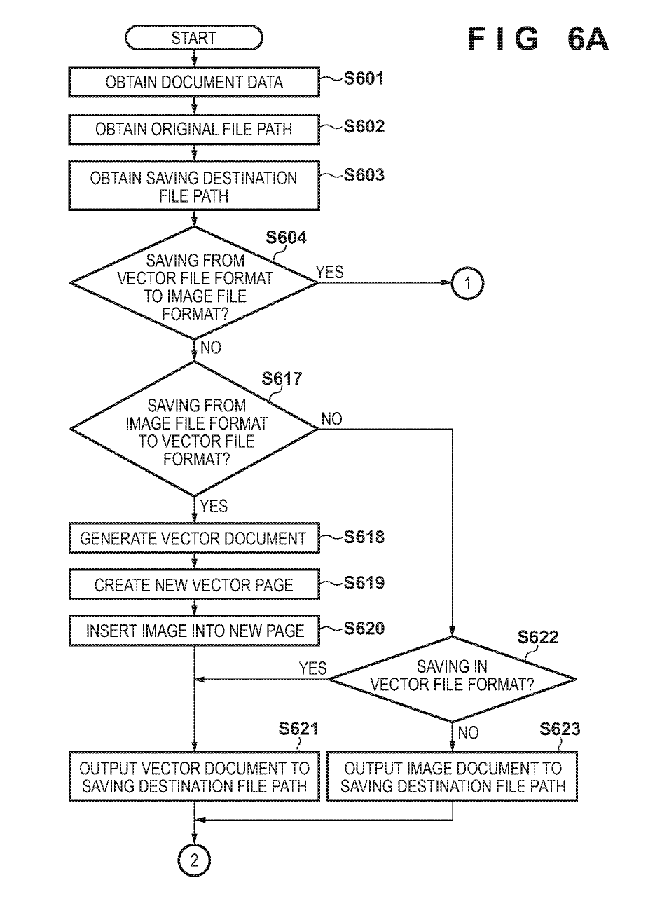

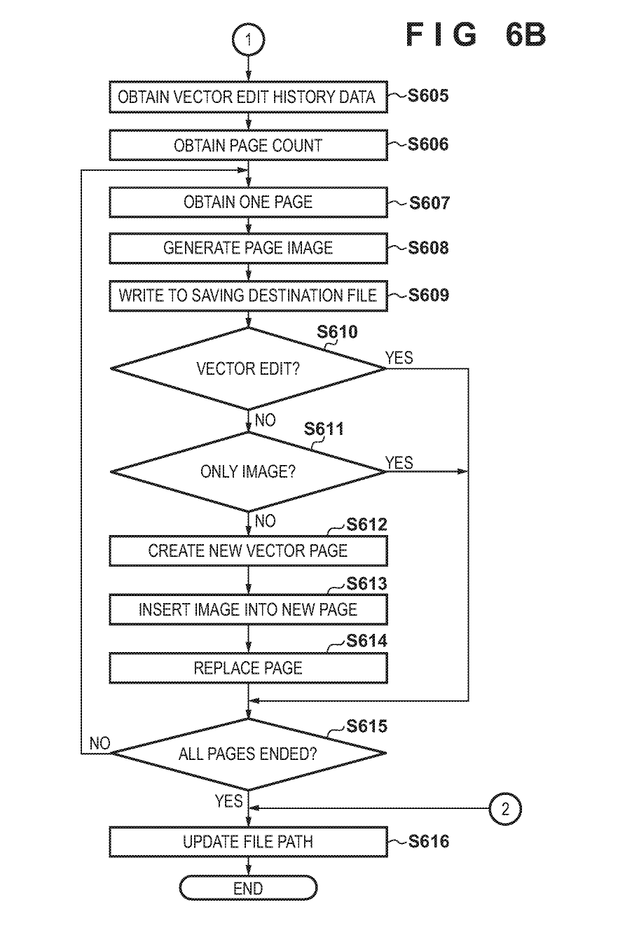

The procedure of processing upon executing saving with another name for the document data 300 according to this embodiment will be described with reference to FIGS. 6A, 6B, 7, 8A, 8B, and 11. More specifically, saving processing of saving document data of a certain format (extension) as a file of a predetermined format designated by the user and updating processing of the document data held as an edit target by the document edit system 200 after the saving will be described. Normally, in a case of saving with another name, another file is saved with a new file name, and the original file is maintained.

In this embodiment, whether to perform imaging of a page is switched depending on the presence/absence of an edit for object data existing in a page of the document data. When a control 1110 is pressed as the operation of saving with another name for document data, the GUI unit 201 detects this operation and issues an instruction corresponding to the operation to the input control unit 202. Upon receiving the instruction, the input control unit 202 displays a saving-with-another-name dialog (not shown). In the saving-with-another-name dialog (not shown), the user can select the location of a saving destination, a file name, and a file format (extension). When these are input, and an OK button (not shown) on the saving-with-another-name dialog is pressed, the GUI unit 201 detects this operation and instructs, via the input control unit 202, the document edit unit 203 to execute saving with another name. Note that the location of the saving destination, the file name, and the extension are held as a file path in an arbitrary area. Upon receiving the instruction, the document edit unit 203 starts the saving-with-another-name processing of the document data. In this processing procedure, the entity of processing is the document edit unit 203 unless it is specifically stated otherwise.

In step S601, the document edit unit 203 accesses the data analysis unit 205 and obtains the document data 300 as the processing target.

In step S602, the document edit unit 203 refers to the document data 300 obtained in step S601 and obtains the file path 305.

In step S603, the document edit unit 203 obtains the file path of a saving destination. As the file path of the saving destination, information input by the user to the above-described saving-with-another-name dialog (not shown) is obtained.

In step S604, the document edit unit 203 determines whether to perform saving to an image file in a state in which the vector document 301 exists in the document data 300 as the processing target. More specifically, it is determined whether the vector document 301 exists in the document data 300 as the processing target, and the extension of the file path obtained in step S603 indicates an image file format. As the result of determination, if saving to an image file in a state in which the vector document 301 exists in the document data 300 is to be performed (YES in step S604), the process advances to step S605. Otherwise (NO in step S604), the process advances to step S617.

In step S605, the document edit unit 203 obtains the vector edit history data 500 for the document data 300 as the processing target.

In step S606, the document edit unit 203 refers to the vector document 301 and the vector pages 302 of the document data 300 as the processing target and obtains a page count.

In step S607, the document edit unit 203 obtains the unprocessed vector page 302 corresponding to one page from the start.

In step S608, concerning the vector page obtained in step S607, the document edit unit 203 generates an image on which drawing contents decided by the object data are reflected. The image generated here is not image data of a vector format but image data of a raster format. That is, conversion into image data of the raster format is performed based on the object data included in the vector page. The conversion method (rasterization) here is not particularly limited, and a known method may be used.

In step S609, the document edit unit 203 instructs the saving/updating unit 204 to additionally write the image generated in step S608 to the file path of the saving destination obtained in step S603. In this process, write to a file (a file of another name) of the image format designated by the user is performed. The file of another name here corresponds to a file format such as a bitmap file.

Next, in steps S610 to S614, an updating operation of the document data 300 that is held for the document edit system 200 to continue an edit after saving with another name is performed. That is, the document data 300 that is the updating target here is data of a vector format based on the original file, and is document data different from the file output to the file path of the saving destination. When the document data in a data state different from the file saved with another name is held, the document edit system 200 can continue the operation in consideration of the contents of an edit performed based on the user instruction.

In step S610, the document edit unit 203 refers to the vector edit history data 500 obtained in step S605, and determines whether object data corresponding to the edit target ID 501 of the vector edit data 510 exists in the vector page obtained in step S607. With this processing, it is determined whether the object data of the vector page of the processing target is edited. If the object data is edited (YES in step S610), the process advances to step S615. If the object data is not edited (NO in step S610), the process advances to step S611.

In step S611, the document edit unit 203 determines whether the vector page of the processing target is formed only by an image object having the same size as the page size. If the vector page is formed only by an image object having the same size as the page size (YES in step S611), updating for the vector page is not particularly performed, and the process advances to step S615. Otherwise (NO in step S611), the process advances to step S612. The otherwise case corresponds to, for example, a case in which a drawing object other than the image exists or a case in which the size of the image is different from the page size. Note that as the method of determining whether the image size is the same as the page size, a threshold of a certain degree may be held, and it may be determined that the sizes equal when the size difference from the page size is a predetermined value or less. Such a size with a predetermined difference or less will be referred to as a size corresponding to the page size.

In step S612, the document edit unit 203 generates the new vector page 302. Note that the page size of the new vector page may be a specific size or may be calculated from the image size included in the vector page of the processing target.

In step S613, the document edit unit 203 inserts and arranges the image generated in step S608, which has the same size as the page size, in the vector page generated in step S612, and adds the inserted image as an image object to the object list 400.

In step S614, the document edit unit 203 replaces the vector page obtained in step S607 with the vector page in which the image is inserted in step S613. That is, the object linked with the vector page of the processing target is changed and deleted from the object list 400. Hence, when steps S612 to S614 are performed, the vector page of the processing target of the vector document is replaced with the vector page in which only the image (image object) is arranged.

In step S615, the document edit unit 203 refers to the page count obtained in step S606 and determines whether the processing has ended for all vector pages. If the processing has ended for all vector pages (YES in step S615), the process advances to step S616. If the processing has not ended for all vector pages (NO in step S615), the process returns to step S607.

In step S616, the document edit unit 203 changes and updates the file path 305 of the file of the processing target to the file path of the saving destination obtained in step S603. Then, the processing procedure ends.

In step S617, the document edit unit 203 determines whether to perform saving to a vector file format in a state in which the image document 303 exists in the document data 300 as the processing target, and the vector document 301 does not exist. If saving to a vector file format in a state in which the vector document 301 does not exist is to be performed (YES in step S617), the process advances to step S618. Otherwise (NO in step S617), the process advances to step S622.

In step S618, the document edit unit 203 generates the new vector document 301. At this point of time, no vector page is linked with the generated vector document 301.

In step S619, the document edit unit 203 refers to the image document 303 and generates the new vector pages 302 as many as the number of pages linked with the image document 303. The page size of the new vector page 302 may be a specific size or may be calculated from the image size.

In step S620, the document edit unit 203 inserts and arranges the image of image data existing in the image page of the image document 303, which has the same size as the page size, in the vector page generated in step S619. When steps S618 to S620 are performed, a vector document in which an image is arranged in each vector page is generated. That is, the new vector pages 302 generated in step S619 is linked with the vector document 301 generated in step S618.

In step S621, the document edit unit 203 instructs the saving/updating unit 204 to output the contents of the generated new vector document 301 to the file path of the saving destination obtained in step S603. After that, the process advances to step S616.

In step S622, the document edit unit 203 determines whether to perform saving to a vector file format in a state in which the vector document 301 exists in the document data 300 as the processing target or perform saving to an image file format in a state in which the image document 303 exists in the document data 300. If saving to a vector file format is to be performed (YES in step S622), the process advances to step S621. If saving to an image file format is to be performed (NO in step S622), the process advances to step S623.

In step S623, the document edit unit 203 instructs the saving/updating unit 204 to output the contents of the image document 303 to the file path of the saving destination obtained in step S603. After that, the process advances to step S616.

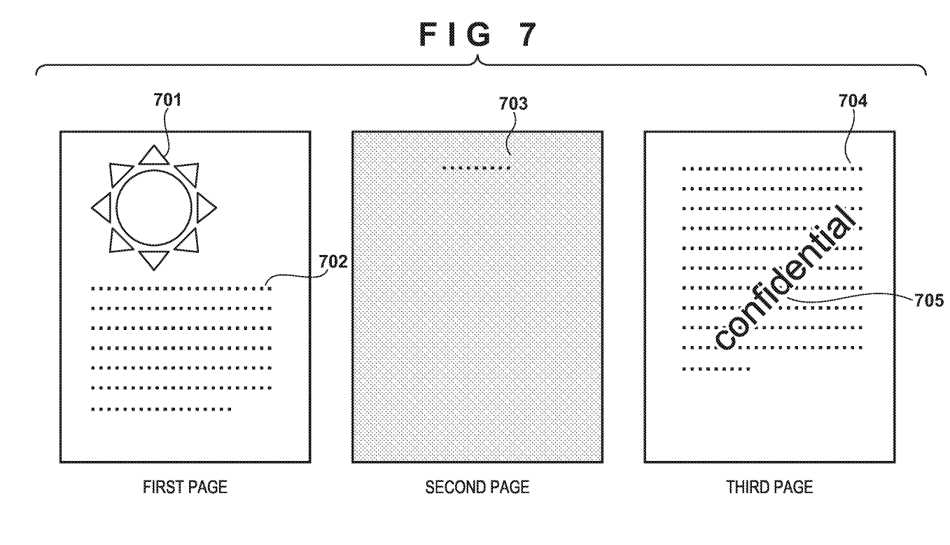

FIG. 7 shows an example of document data that holds a vector document as a processing target at the time of saving with another name according to this embodiment. In this example, document data is formed by three pages. An image object 701 and a text object 702 are arranged as objects in the first page. The second page is a page generated by scan, and an image object 703 is arranged over all of the page. A text object 704 is arranged in the third page. Additionally, in the third page, a text object 705 is added after the document file of the vector format is opened by the document edit system 200.

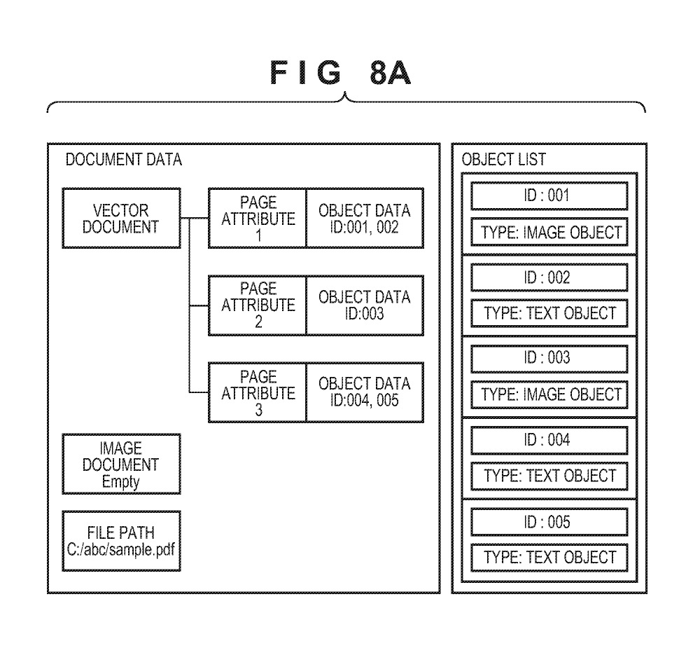

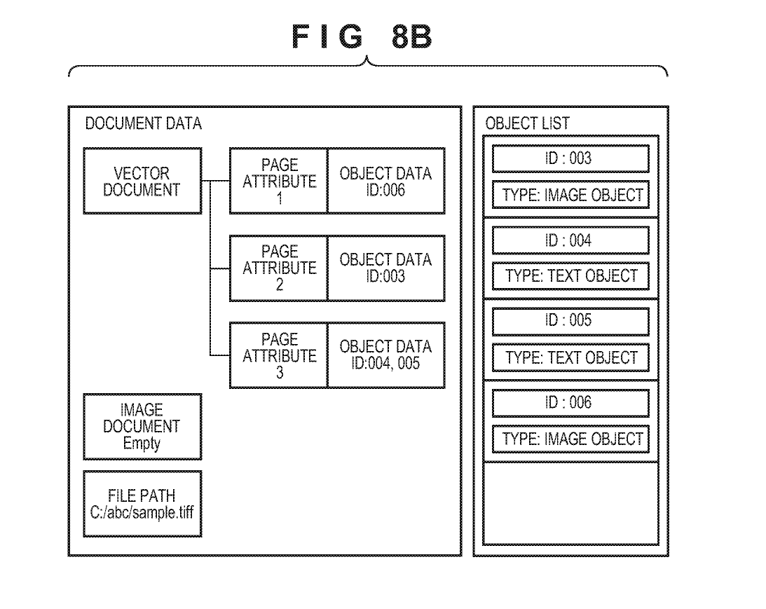

FIG. 8A is a view showing the states of the document data and the object list in a state in which the document data file shown in FIG. 7 is opened by the document edit system 200, and the text object 705 is added. Three pages are linked with the vector document, and the IDs of the object data 701 to 705 shown in FIG. 7 are held as 001 to 005. The path of the file of the document data is stored in the file path. The image document is empty. The document data shown in FIG. 8A is formed by the file format of a PDF file.

FIG. 8B is a view showing the states of the object list and the document data held as an edit target in the document edit system 200 after the document data shown in FIG. 8A is saved with another name as an image file format. A case in which the document data is saved with another name as an image file with an extension “.tiff” is shown here. For the first page, the edit is not performed. Hence, when the processes of steps S612 to S614 are performed, an image object with an ID: 006 is arranged. For the second page, the edit is not performed, and an image object is not arranged over all of the page. Hence, when the determination of step S611 is performed, the process advances to step S615, and the data is not particularly updated. For the third page, since the text object of the ID: 005 is added, the process advances to step S615 by the determination of step S610, and the object data of the vector document is maintained without being updated.

By this result, after saving of the document data to the image file, for the first and second pages, the edit or correction of the image object (image data) can be performed. For the third page, the edit of the object data can be performed. In other words, image data in a file format based on a user instruction and corresponding document data for the edit which is used in the document edit system 200 are generated. For this reason, the output file is the document data of the file format according to the user instruction, and the file as the target for which the edit operation is to be continued has a format capable of editing on a page basis.

### Processing at Time of Document Edit

### Edit of Object Data

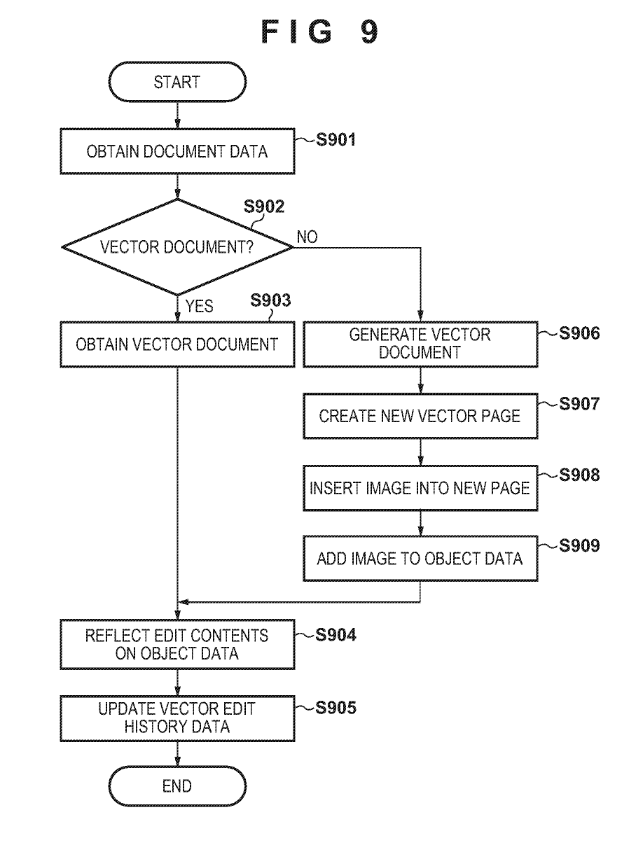

FIG. 9 is a flowchart showing an example of a processing procedure when performing an edit of object data for the vector document of document data. For example, the control 1112 on the main window 1101 is operated to insert an annotation, thereby starting this processing. In this processing procedure, the entity of processing is the document edit unit 203 unless it is specifically stated otherwise.

In step S901, the document edit unit 203 obtains the document data 300 as the processing target.

In step S902, the document edit unit 203 refers to the obtained document data 300 and determines whether the vector document 301 exists. If the vector document 301 exists (YES in step S902), the process advances to step S903. If the vector document 301 does not exist (NO in step S902), the process advances to step S906.

In step S903, the document edit unit 203 obtains the vector document 301 from the document data 300.

In step S904, the document edit unit 203 reflects the edit contents on the object data of the vector page 302 and the object list 400 in accordance with a user operation. For example, when an annotation is inserted, the ID 401 of the added annotation is given to the object data of the vector page 302 as the operation target, and the object data 410 of the inserted annotation is added to the object list 400. In addition, when an annotation is deleted, the ID 401 of the corresponding annotation is deleted from the object data of the vector page 302 as the operation target, and the object data 410 of the deleted annotation is deleted from the object list 400. Furthermore, when an edit operation such as movement of a position or a color change is performed, the object data of the corresponding annotation is updated from the object list 400 in accordance with the contents of the edit.

In step S905, the document edit unit 203 updates the vector edit history data 500. For example, when annotation insertion or edit is performed, the vector edit data 510 is added in a state in which the ID 401 of the annotation is set to the edit target ID 501, “annotation insertion” is set to the edit contents 502, and the edit target object data 503 is empty. When annotation deletion is performed, the vector edit data 510 is added in a state in which the ID 401 of the annotation is set to the edit target ID 501, “annotation deletion” is set to the edit contents 502, and the object data of the deleted annotation is stored in the edit target object data 503. After that, the processing procedure ends.

In step S906, the document edit unit 203 generates the new vector document 301 to edit the object data. At this point of time, no vector page is linked with the generated vector document 301.

In step S907, the document edit unit 203 refers to the image document 303 and creates the vector pages 302 as many as the number of image pages 304 linked with the image document 303. The page size of the vector page may be a specific size or may be calculated from the image size.

In step S908, the document edit unit 203 inserts the image data of the image pages 304 in the vector pages 302 generated in step S907 at the same size as the page size.

In step S909, the document edit unit 203 adds, as the image object, the images inserted in step S908 to the object data of the vector pages 302 and the object list 400. Then, the process advances to step S904.

When this processing procedure is applied, object data can be edited in a state in which any of the vector document 301 and the image document 303 exists, and the object data existing in the vector document 301 can be updated. After this processing, when saving the file with another name, the process advances to the processing shown in FIGS. 6A and 6B. Accordingly, as shown in FIGS. 6A and 6B, for the vector page that is determined in step S610 to have undergone a vector edit, the object data is continuously held without performing imaging, thereby enabling the edit of the object data even after saving with another name.

### Edit of Image

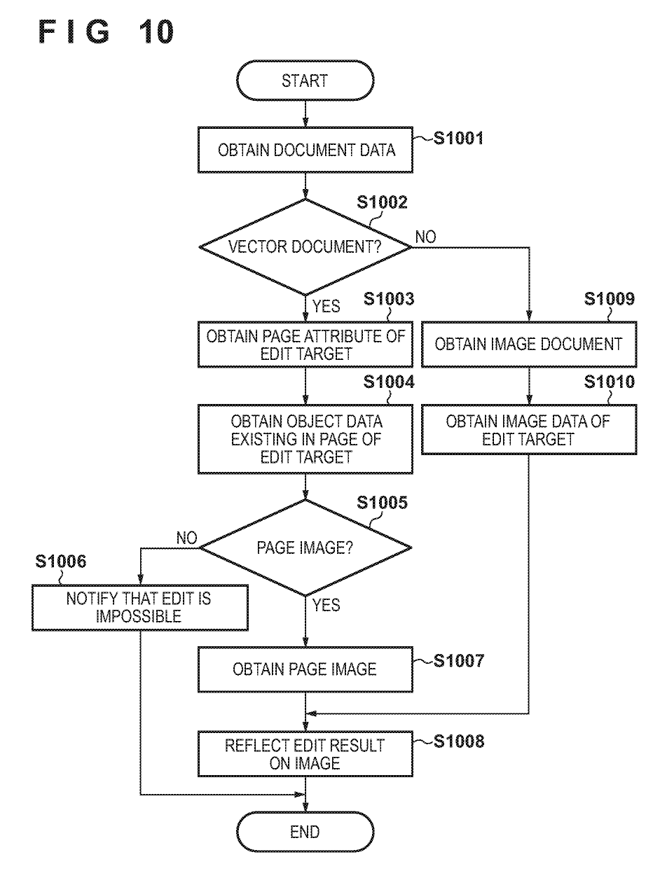

FIG. 10 is a flowchart showing an example of a processing procedure of editing an image object existing in the vector document 301 of the document data 300 or image data of the image document 303. For example, the control 1113 on the main window 1101 is operated to correct an image, thereby starting this processing. In this processing procedure, the entity of processing is the document edit unit 203 unless it is specifically stated otherwise.

In step S1001, the document edit unit 203 obtains the document data 300 as the processing target.

In step S1002, the document edit unit 203 refers to the obtained document data 300 and determines whether the vector document 301 exists. If the vector document 301 exists (YES in step S1002), the process advances to step S1003. If the vector document 301 does not exist (NO in step S1002), the process advances to step S1009.

In step S1003, the document edit unit 203 obtains the page attribute of the vector page 302 of the edit target.

In step S1004, the document edit unit 203 obtains the object data 410 existing in the vector page 302 of the edit target.

In step S1005, the document edit unit 203 determines whether a processable image exists. In this processing, referring to the page size of the page attribute obtained in step S1003 and the drawing information 405 of the object data 410 obtained in step S1004, it is determined whether an image (page image) corresponding to the page size exists. Upon determining that a page image exists (YES in step S1005), the process advances to step S1007. Upon determining that a page image does not exist (NO in step S1005), the process advances to step S1006.

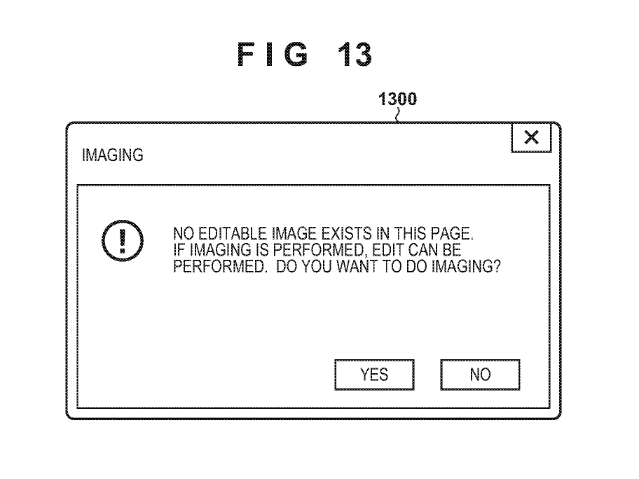

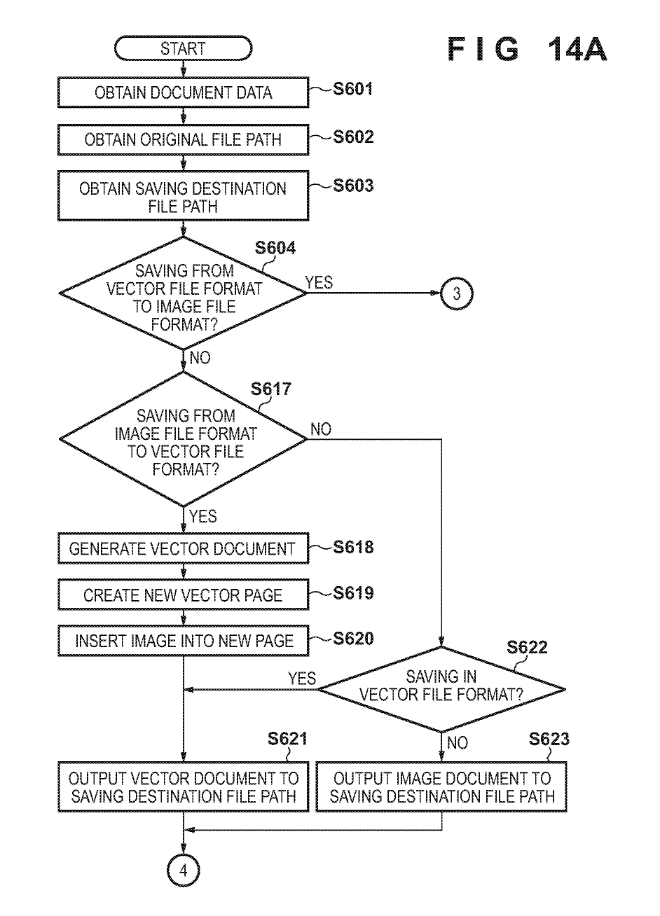

In step S1006, the document edit unit 203 displays a message representing that the page selected as the processing target cannot be edited. After that, the processing procedure ends. Note that in step S1006, instead of displaying a message representing that an edit cannot be performed, a message such as a message 1300 as shown in FIG. 13, which represents that the edit can be performed by performing imaging, may be notified. In this case, by pressing a YES button by the user, imaging of the page of the processing target may be performed, and the edit of the image may be enabled.

In step S1007, the document edit unit 203 obtains, from the object list 400, the page image determined to correspond to the page size in step S1005.

In step S1008, the document edit unit 203 performs an edit such as image correction for the page image obtained in step S1007 or the image data of the image page 304 obtained in step S1010, and reflects the result. After that, the processing procedure ends.

In step S1009, the document edit unit 203 obtains the image document 303 from the document data 300.

In step S1010, the document edit unit 203 refers to the image document 303 and obtains image data from the image page 304. After that, the process advances to step S1008.

When this processing is applied, an image edit such as image correction can be performed for a page in which a page image exists in the vector pages of the vector document 301. In addition, an image edit can be performed in a case in which an image document exists, as a matter of course. To save the file with another name after this processing, the process advances to the processing shown in FIGS. 6A and 6B. Accordingly, as shown in FIGS. 6A and 6B, for the vector page that is determined in step S610 to have not undergone a vector edit, imaging is performed, thereby enabling an edit as an image after saving with another name.

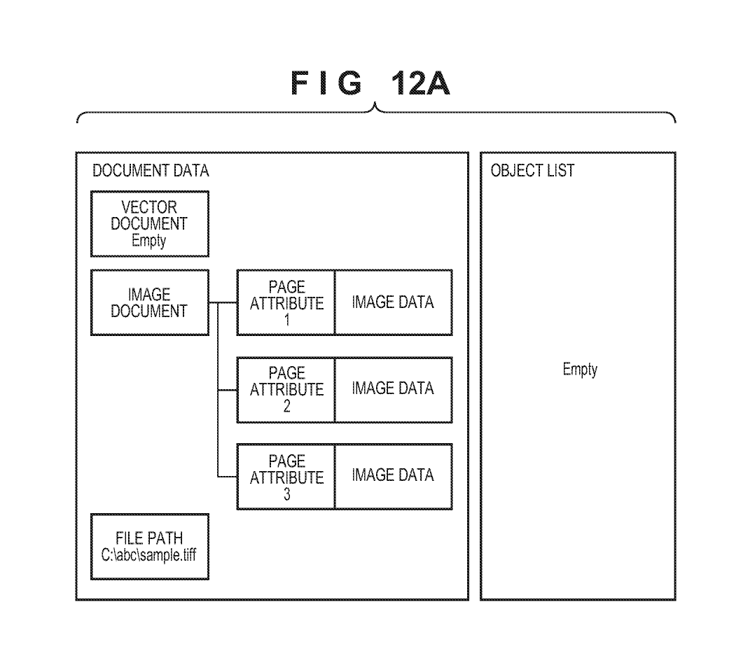

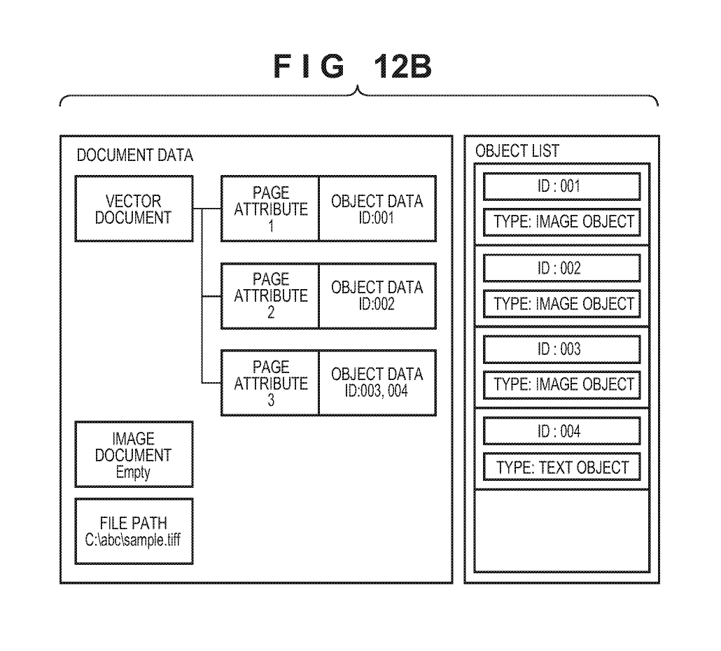

FIG. 12A is a view showing document data and an object list in a state in which a file including an image document is opened as an edit target. In this document data, the vector document is empty. For this reason, the object list is also empty.

Three pages are linked with the image document. The file path stores the path of the image document file. FIG. 12B is a view showing the state of the document data after an edit of vector data (addition of a text object) is performed for the third page of the document data shown in FIG. 12A. For all of the first page, the second page, and the third page, new vector documents are generated in steps S906 to S909 of FIG. 9, and image objects are inserted into the vector pages of the first to third pages. For the third page, a text object is further added in steps S904 and S905.

As described above, when the processing at the time of saving with another name and the processing of document edit according to this embodiment are applied, the page to be imaged after saving with another name switches on a page basis in accordance with the edit contents of the user. For a page that has not undergone an edit, an image edit or correction as a final product can be performed by performing imaging. A page that has undergone an edit continuously holds an object, and therefore, an edit as an object data can continuously be performed.

### Second Embodiment

The second embodiment of the present invention will be described next. The second embodiment is different from the first embodiment in the processing method concerning imaging of a vector page in a case in which it is determined to do saving from a vector file format to an image file format in the processing of saving document data with another name shown in FIGS. 6A and 6B. Only the difference will be described here, and a repetitive description will be omitted.

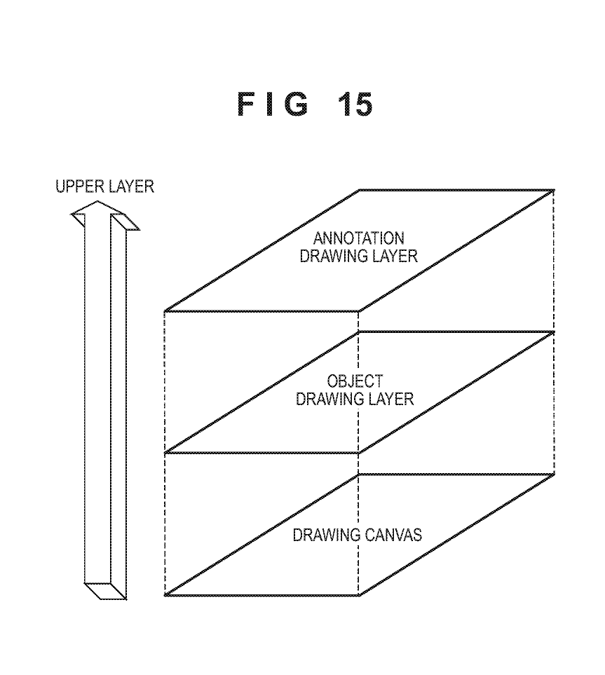

In the second embodiment, document data including a drawing layer as shown in FIG. 15 is processed. FIG. 15 is a view schematically showing the drawing layer of document data. The drawing layer of document data is formed by a plurality of layers, and an annotation layer (annotation drawing layer) exists in a state in which it is overlaid on a document layer (object drawing layer). An object can be arranged in each of the document layer and the annotation layer. That is, in this embodiment, the object of the annotation layer is drawn as an upper layer.

In the first embodiment, the presence/absence of execution of imaging is decided based on the vector edit history data 500, as in step S610. However, for document data having the drawing layer structure including two layers as shown in FIG. 15, it is considered that an edit of the object of the document layer is not performed, and only the object of the annotation layer (uppermost layer) is edited. In this case, if priority is given to the presence/absence of an edit, and a page is imaged including the object of the annotation layer at the time of saving with another name, the annotation cannot be re-edited. As a result, the operability after saving is considered to lower.

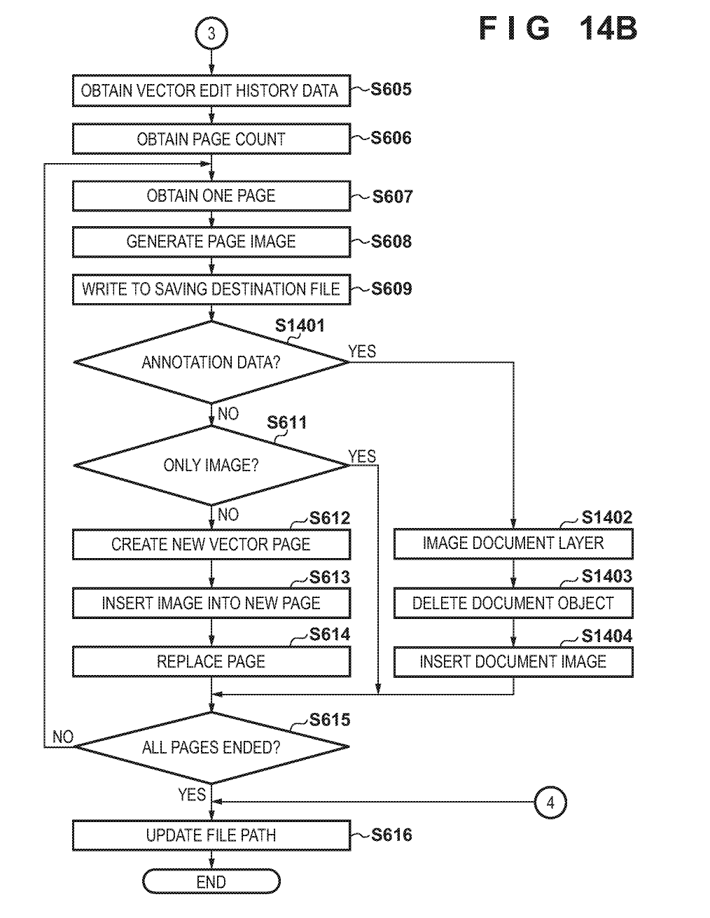

In the second embodiment, a form to solve the above-described problem will be described with reference to FIGS. 14A and 14B. The same step numbers as in FIGS. 6A and 6B described in the first embodiment denote the same steps.

After the process of step S609, in step S1401, a document edit unit 203 determines whether object data as an annotation exists in the vector page as the processing target obtained in step S607. If object data exists (YES in step S1401), the process advances to step S1402. If object data does not exist (NO in step S1401), the process advances to step S611.

In step S1402, the document edit unit 203 generates image data on which the drawing contents of the object of the document layer are reflected. That is, image data on which the drawing contents of object arranged in the layer other than the uppermost layer (annotation layer) are reflected is generated.

In step S1403, the document edit unit 203 deletes the object of the document layer from the vector page and the object list. That is, the object arranged in the layer other than the uppermost layer (annotation layer) is deleted.

In step S1404, the document edit unit 203 inserts the image generated in step S1402, which has the same size as the page size, in the vector page and the object list as an image object. That is, in the page to which steps S1402 to S1404 are applied, the existing document object is deleted, and the image object having the same size as the page size and the existing annotation object exist. After that, the process advances to step S615.

According to this embodiment, the page to be imaged at the time of saving with another name can be switched in accordance with the drawing layer in which object data is arranged in document data. For this reason, in document data in which a drawing layer with high edit property such as an annotation exists, a more efficient edit can be performed after saving with another name.

Note that in this embodiment, two layers have been exemplified as layers in which objects are arranged. However, the present invention is not limited to this, and document data may be formed by more layers, and objects may be arranged in a superimposed manner. In this case, only object data corresponding to the object arranged in the uppermost layer may be held in a vector format, and objects in layers other than the uppermost layer may be imaged and held.

Additionally, in this embodiment, an annotation has been described as an example of an object arranged in the uppermost layer. However, the present invention is not limited to this. The object may be another object assumed to be edited frequently or may be set arbitrarily by the user.

Embodiment(s) of the present invention can also be realized by a computer of a system or apparatus that reads out and executes computer executable instructions (e.g., one or more programs) recorded on a storage medium (which may also be referred to more fully as (‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-195374, filed Oct. 5, 2017, which is hereby incorporated by reference herein in its entirety.

What is claimed is:

1. An information processing apparatus comprising:
an edit unit configured to edit document data based on an instruction of a user,
wherein in a case in which an instruction to output document data of a vector format using a file format of a raster format is received, the edit unit outputs the document data using the file format of the instructed raster format, specifies, for each page included in the document data, whether to hold data of an object included in a page as data of the vector format or hold the data as data of the raster format, and holds each page including data of an object of the specified format as data for an edit.

2. The apparatus according to claim 1, wherein of the pages included in the document data, a page in which the object of the data of the vector format included in the page has undergone the edit by the edit unit is specified as the page that holds the data of the object as the data of the vector format.

3. The apparatus according to claim 1, wherein of the pages included in the document data, a page formed by image data of the raster format in which an included object occupies the entire page is specified as the page that holds the data of the object as the data of the raster format.

4. The apparatus according to claim 1, wherein of the pages included in the document data, in a page specified as the page that holds the data of an included object as the data of the raster format, the data of the object of the vector format included in the page is converted into the data of the raster format and held.

5. The apparatus according to claim 1, wherein a page of the document data of the vector format is formed by a plurality of layers in each of which an object can be arranged, and
of the pages included in the document data, for a page including an object arranged in an uppermost layer of the plurality of layers, data of the object arranged in the uppermost layer is held as data of the vector format, and as for data of the object arranged in a layer other than the uppermost layer, the data of the vector format is converted into data of the raster format and held.

6. The apparatus according to claim 5, wherein the object arranged in the uppermost layer is an object representing an annotation.

7. The apparatus according to claim 1, wherein in a case in which the document data is to be edited after the instruction to output the document data of the vector format using the file format of the raster format is received, the edit unit performs the edit using the data for the edit.

8. A method of controlling an information processing apparatus including an edit unit configured to edit document data based on an instruction of a user,
wherein in a case in which an instruction to output document data of a vector format using a file format of a raster format is received, the document data is output using the file format of the instructed raster format, whether to hold data of an object included in a page as data of the vector format or hold the data as data of the raster format is specified for each page included in the document data, and each page including data of an object of the specified format is held as data for an edit by the edit unit.

9. A non-transitory computer-readable storage medium for causing a computer to function as an edit unit configured to edit document data based on an instruction of a user,
wherein in a case in which an instruction to output document data of a vector format using a file format of a raster format is received, the edit unit outputs the document data using the file format of the instructed raster format, specifies, for each page included in the document data, whether to hold data of an object included in a page as data of the vector format or hold the data as data of the raster format, and holds each page including data of an object of the specified format as data for an edit.
